(19) United States
(12) Patent Application Publication
(10) Pub. No.: US 2018/0106612 A1
(43) Pub. Date: Apr. 19, 2018

(54) RANGE FINDING BINOCULARS

(71) Applicant: Superior Optics Company, Brea, CA (US)

(72) Inventors: Chen Mingshu, Shanghai City (CN); Liang Guangqu, Guangzhou City (CN)

(73) Assignee: Superior Optics Company, Brea, CA (US)

(21) Appl. No.: 15/608,167

(22) Filed: May 30, 2017

(30) Foreign Application Priority Data
Oct. 19, 2016 (CN) 201610909856.X
Oct. 19, 2016 (CN) 211621136476.9

(51) Int. Cl. G01C 3/08; G01S 7/481; G01S 7/51; G02B 23/04; F41G 3/06; G02B 23/10; G02B 23/18

(52) U.S. Cl. CPC G01C 3/08; G01S 7/4812; G01S 7/51; G02B 27/10; F41G 3/065; G02B 23/10; G02B 23/18; G02B 23/04

(57) ABSTRACT

A laser ranging binocular for distance detection includes a first lens barrel having a first eyepiece and a first objective lens, and a second lens barrel having a second eyepiece and a second objective, lens with the first and second lens barrels rotatable relative to each other. A laser transmitter in the first lens barrel is operable to transmit a laser beam through a first optical splitting unit, the propagated light is directed through a first prism and through the first objective lens towards a target object. Laser light reflected from the target object is received by the second objective lens and directed to a second prism, which directs the received light to a second optical splitting unit and to a laser receiver. A processor in communication with the laser transmitter and receiver measures elapsed time and calculates a distance to the target.

### CROSS-REFERENCE TO RELATED APPLICATIONS

This application claims the benefit of Chinese patent application No. 211621136476.9 filed Oct. 19, 2016, and Chinese utility model patent application No. 201610909856.X filed Oct. 19, 2016.

### FIELD OF THE INVENTION

The present invention relates to devices for measuring distances, and specifically relates to laser range-finding binoculars.

### BACKGROUND OF THE INVENTION

The measurement of a distance between two objects on the ground can generally be determined by measuring the length of a line between two points on the ground corresponding to the locations of the objects. For example, measurement of the horizontal distance between two points is often accomplished by determining the length, along a level surface, of a line projected between the two points. With one of the points known or at a fixed location, the distance measurement to the other point can thus be determined by various means or methods, including ruler-measured distance, sight distance, method of Parallax ranging, Euclidian Distance Matrix Analysis (EDMA), and other methods known in the art. The obtained distances between two objects or points on the ground are commonly used in the course of performing triangulation determination of locations, surveys, topographical studies, and engineering projects.

Commonly known tools used for distance-of-sight ranging are theodolite telescopes and sight gauges. Theodolite telescopes use an upper and lower cross-wire, with two short cross-wires read in the line of sight from top to bottom. With the cross wires aligned with an object, the difference between the two cross wire readings, along with other data, allows a user to calculate the distance to the target object. However, setting up and aligning the equipment to most accurately obtain readings from theodolite telescopes and to calculate the distance to a target object is often cumbersome and inconvenient. Furthermore, the accuracy of such parallax measurement is lacking. Thus, there remains a need in the art for a system and method that provide accurate, convenient distance measurements to line-of-sight objects.

### SUMMARY OF THE INVENTION

In view of problems with known apparatus for measuring distance, the present invention is directed to a laser range-finding binocular which is easy to operate and which can quickly and accurately measure a distance to a target object.

In one embodiment, the laser ranging binocular of the present invention includes first and second lens barrels, with first and second eyepieces and first and second objective lenses positioned at opposite ends of the corresponding lens barrels. Each lens barrel is attached to a rotation mechanism which allows the lens barrels to be rotated with respect to each other about the rotation mechanism.

A laser transmitter in the first lens barrel emits a laser beam that is directed through a first optical splitter unit, through a first prism, and through the first objective lens and to a target object.

Laser light reflected from the target object is captured through the second objective lens and collated through a second prism and second optical splitter unit which directs the collated reflected light beam to a laser light detector.

Processing circuitry in communication with the laser light transmitter and laser light receiver measures the time for emitted light to be reflected back from the target object and calculates the distance to that object based on that measured time.

The calculated distance to the target object is displayed on a display device in the first lens barrel which projects the calculated distance to the first eyepiece for viewing by a user of the binocular.

In preferred embodiments the first and second optical beam splitters are beam splitting prisms.

In alternative embodiments, the beam splitting prisms comprise two optical splitters combined with flat glass, in other embodiments the beam splitting prisms comprise two beam splitting prisms in close proximity.

In further alternative embodiments, a focal length adjusting mechanism is included between the first and second lens barrels.

In other alternative embodiments, the objective lenses are larger than the corresponding eyepiece lenses.

In further alternative embodiments, a filter is placed between the laser light transmitter and the beam splitting unit to limit the emitted laser light to a particular wavelength or band of wavelengths.

In other alternative embodiments, a lens is positioned between the display unit and the first eyepiece lens to focus the displayed measured distance to a user.

The laser ranging binocular of the present invention simple and easy to use, is readily adaptable to varying terrain, quickly and accurately provides measurement results, and overcomes the complex set-up and use requirements of known distance measurement systems and devices.

### BRIEF DESCRIPTION OF DRAWINGS

The following drawings are included for illustration and explanation of the exemplary embodiments only and are not intended to restrict the scope of the invention.

FIG. 1 is a schematic diagram of a laser range finding binocular in accordance with an exemplary embodiment of the present invention;

FIG. 2 is a schematic diagram of a laser range finding binocular in accordance with a second an alternative exemplary embodiment of the present invention;

FIG. 3 is a schematic diagram of a laser range finding binocular in accordance with an alternative exemplary embodiment of the present invention;

FIG. 4 is a schematic diagram of a laser range finding binocular in accordance with an alternative exemplary embodiment of the present invention;

FIG. 5 is a schematic diagram of a laser range finding binocular in accordance with an alternative exemplary embodiment of the present invention;

FIG. 6 is a schematic diagram of a laser range finding binocular in accordance with an alternative exemplary embodiment of the present invention.

### DETAILED DESCRIPTION

The following description, in combination with the drawings, describes various exemplary embodiments in of the present invention. It should be understood that the embodiments shown are exemplary in nature and not limiting, and that other embodiments of the invention are contemplated and within the scope of the present invention. It should be further understood that various features of the multiple embodiments may be combined and arranged other than as specifically depicted and/or described, all within the scope of the present invention.

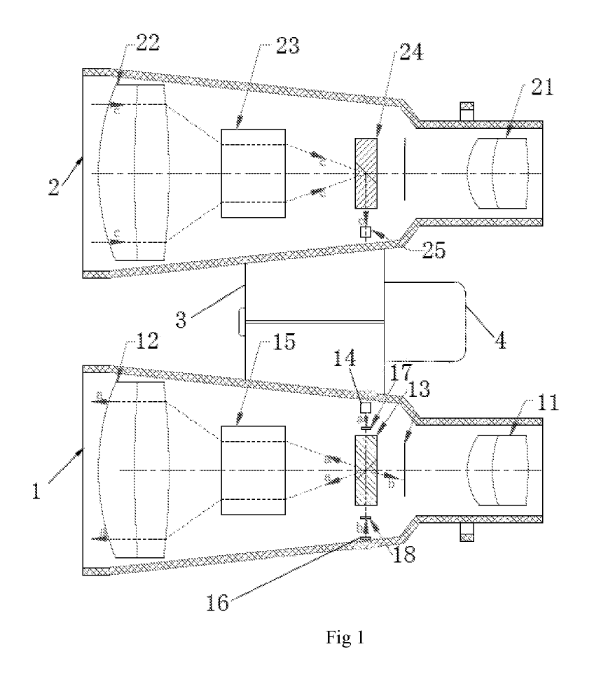

Looking first to FIG. 1, a schematic diagram of a laser range-finding binocular for use in obtaining a distance measurement to a target object in accordance with an exemplary embodiment of the present invention includes a first lens barrel 1 and a second lens barrel 2, positioned on opposite sides of a rotation mechanism 3. The rotation mechanism 3 allows relative rotation of the first lens barrel 1 with respect to the second lens barrel 2 about the rotation mechanism 3, and likewise allows relative rotation of the second lens barrel 2 with respect to the first lens barrel 1 about the mechanism 3.

First lens barrel 1 includes a first eyepiece 11 positioned near a first end of the first lens barrel 1, and a first objective lens 12 positioned near the opposite end of the first lens barrel 1. A first optical splitter unit 13 is positioned in the first lens barrel 1, near the first eyepiece 11 and between the first eyepiece 11 and the first objective lens 12. Preferably, the first optical splitter unit 13 is positioned at a predetermined distance between the first eyepiece 11 and the first objective lens 12.

A laser transmitter 14, positioned to the side (i.e., away from the center axis of the first lens barrel 1) of the first optical splitter 13, is operable to emit a laser beam a into the first optical splitter 13. As seen in FIG. 1, the first optical splitter unit 13 splits the transmitted laser beam into two separate beams a, a which are directed or refracted to a first prism 15, positioned between the first optical splitter unit 13 and the first objective lens 12. The first prism 15 and the first objective lens 12 direct the split laser beams a, a into a parallel beam of laser irradiation directed towards the object targeted for distance measurement.

Second lens barrel 2 includes a second eyepiece 21 positioned near a first end of the second lens barrel 2, and a second objective lens 22 positioned near the opposite end of the second lens barrel 2. A second optical splitter unit 24 is positioned in the second lens barrel 2, near the second eyepiece 21 and between the second eyepiece 21 and the second objective lens 22. Preferably, the second optical splitter unit 24 is positioned at a predetermined distance between the second eyepiece 21 and the second objective lens 22.

The second objective lens 22 is operable to receive laser light c, c reflected from a target object. The received laser light is directed from the second objective lens 22 towards a second prism 23, which further directs the received laser light reflected from the target object into the second optical splitter unit 24 which collates the received laser light into a single laser beam c. The second optical splitter unit 24 directs the single laser beam c to a laser receiver 25, operable to detect the light from that laser beam and to provide a signal indicative of that detection.

Processing circuitry (not shown in the figure) in communication with the laser transmitter 14 and the laser receiver 25 is operable to control the activation of the laser transmitter 14 and to receive a signal from laser receiver 25 indicating detection of laser light reflected from a target object. The processing circuitry is further operable to measure the time between transmitting the laser beam a and receiving the reflected laser light beam c, and to calculate the distance to the target object based on that measured time. A display device 16 in communication with the processing circuitry is operable to display the calculated distance as a value. The displayed distance is visible by a user through first eyepiece 11, as the displayed value is projected from the display device 16, through lens 18 and into the first optical splitter unit 13 where it can be viewed through the first eyepiece 11.

In the embodiment as just described, when using the laser range-finder binocular to measure a distance, the user views a target object through the first eyepiece 11, and turns on or activates the laser transmitter 14. Upon activation, the laser transmitter 14 emits a laser light beam into the first optical splitter unit 13, which further refracts the laser into the first beam-splitting prism 15. The beam from beam-splitting prism 15 is transmitted through the first objective lens 12 and the transmitted laser light irradiates the object being targeted for distance measurement.

The target object will reflect at least a part of the transmitted laser light back towards that binocular. That reflected laser light c is captured through the second objective lens 22 and is directed through the second prism 23 and to the second optical splitter unit 24. The second optical splitter unit 24 directs the collated received reflected laser beam c to laser receiver 25. As described above, processing circuitry in communication with the laser transmitter 14 and the laser receiver 25 measures the time elapsed between activation of the laser and detection of reflected laser light. Using the known speed of light, the distance to the target object is calculated and displayed on display device 16. Preferably, with the distance between the first optical splitter unit 13 and the first eyepiece 11 at a preset distance, the image displayed on display device 16 is visible to the user through first eyepiece 11.

In preferred embodiments, the first and second optical splitter units 13, 24 are beam splitting prisms.

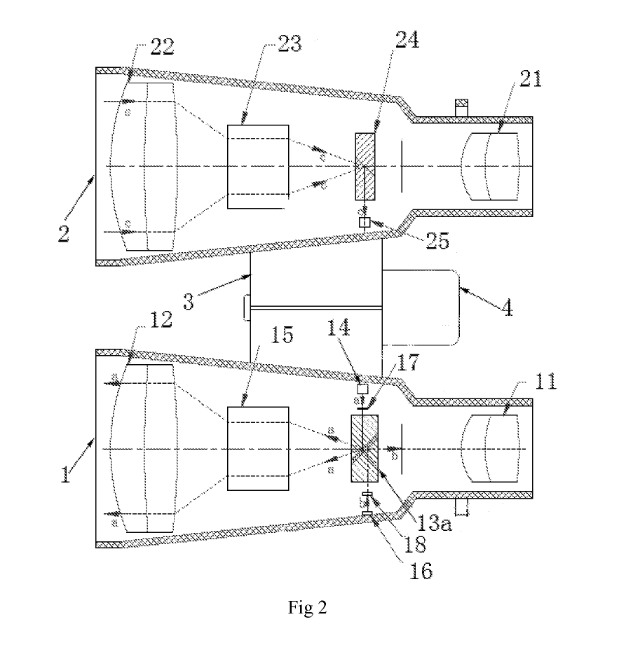

Turning to FIG. 2, in an alternative embodiment, the first optical splitter 13a in the first lens barrel 1 is a beam splitting prism comprising two optical prisms and flat glass.

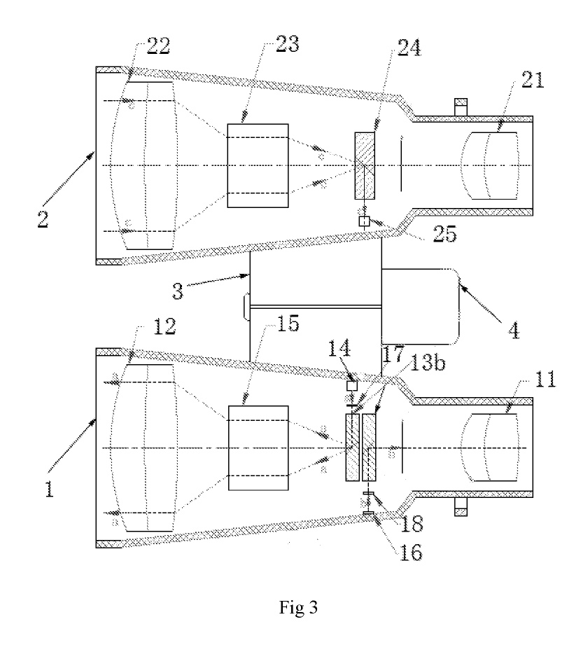

In an alternative embodiment as shown in FIG. 3, the first optical splitter unit 13b is formed by two beam splitting prisms positioned in close proximity.

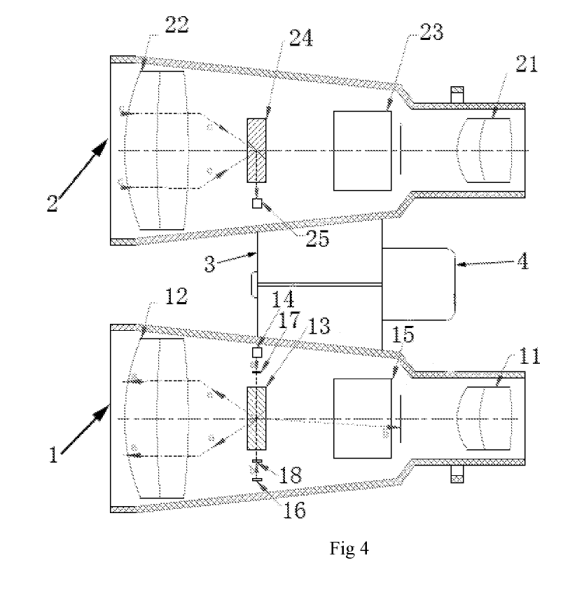

Looking to FIG. 4, in an alternative embodiment the first optical splitter unit 13 in the first lens barrel 1 is positioned nearer to the first objective lens 12 with the first prism 15 positioned between the first optical splitter unit 13 and the first eyepiece 11. Similarly, in this embodiment, the second optical splitter unit 23 is positioned nearer to the second objective lens 22 with the second prism 23 positioned between the second optical splitter unit 24 and the second eyepiece 21.

In a manner similar to that described previously, to measure a distance to an object a user views, through first eyepiece 11, a target object. Upon acquiring the desired target object in the first eyepiece 11 the user activates the laser transmitter 14, for example by pressing a switch in communication with the processing circuitry. The emitted laser light is transmitted from the binocular, through the first objective lens 12, to the target object. Laser light reflected from the target object is received by the second objective lens 22, which directs the acquired reflected light to the second optical splitter unit 24, which further directs the reflected light to the laser receiver 25.

The time from transmission of the laser light to detection of the reflected laser light is measured by the processing circuitry which calculates the distance to the target object. The calculated distance is displayed on display device 16 and viewed by the user through first eyepiece 11 in a manner similar to that previously described.

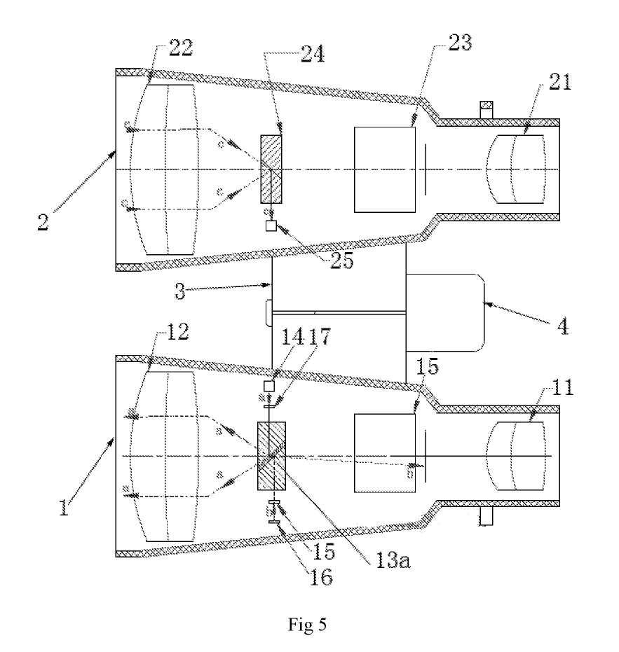

In an alternative embodiment as depicted in FIG. 5, a filter 17 is positioned between the first optical splitter 13a and the laser transmitter 14. The filter 17 is operable to transmit light of a specific frequency, or band of frequencies, so that only a desired wavelength of light is transmitted from the binocular. In this embodiment, the first optical splitter 13a is a beam splitting prism comprising two optical prisms and flat glass.

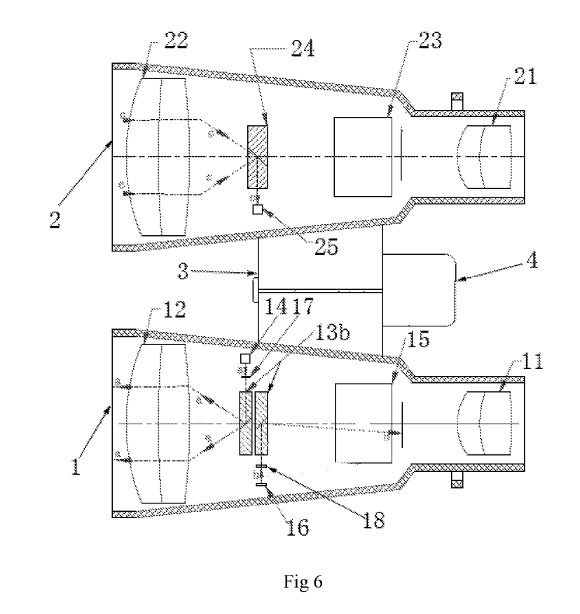

In a further alternative embodiment as depicted in FIG. 6, a lens 18 is positioned between the display device 16 and the first optical splitter unit 13b. The lens 18 allows the image displayed on display device 16 (i.e., the measured distance to the target object) to be focused through the first optical splitter unit to the first eyepiece 11 for viewing by a user. In this embodiment, the first optical splitter unit 13b is a beam splitting prism comprised of two beam splitting prisms positioned in close proximity.

In further alternative embodiments, a focal length adjusting mechanism 4 is arranged between the first lens barrel 1 and the second lens barrel 2 to allow adjustment of the focal length of the binocular by allowing movement of the first and second eyepieces 11, 21, toward and away from the first and second objective lenses 12, 22.

In other preferred embodiments, the first objective lens 12 is larger than the first eyepieces 11, and the second objective lens 22 is larger than the second eyepiece 21.

In one exemplary embodiment, the display device 16 is a liquid crystal display (LCD). In other exemplary embodiments, other known display technologies may be used.

The embodiments described herein are exemplary in nature and are not intended to limit the method and scope of protection of the present invention. Other embodiments and variations of the described embodiments are contemplated and such would be understood by those skilled in the art to be within the scope of the present invention.

1. A laser range-finding binocular for measuring distance to a target object, comprising:
a first lens barrel comprising a first eyepiece and a first objective lens positioned at opposite ends of the first lens barrel;
a second lens barrel comprising a second eyepiece and a second objective lens positioned at opposite ends of the second lens barrel;
a first optical splitter positioned in the first lens barrel and a second optical splitter positioned in the second lens barrel;
a laser light transmitter positioned in the first lens barrel, operable to emit and direct a laser beam into the first optical splitter;
a laser light detector positioned in the second lens barrel, operable to detect laser light reflected from a target object;
processing circuitry operable to measure an elapsed time between activation of the laser light transmitter and detection of light by the laser light detector and to calculate a distance to the target object based on the elapsed time; and
a display device in communication with the processing circuitry, the display device operable to display the calculated distance to the target object, wherein the display device is positioned adjacent to the first optical splitter such that a distance presented on the display device is viewable through the first eyepiece through the first optical splitter.

2. The laser range-finding binocular of claim 1, further comprising:
a rotation mechanism positioned between and attached to the first and second lens barrels such that the first and second lens barrels are rotatable with respect to each other about the rotation mechanism.

3. The laser range-finding binocular of claim 1, wherein the first and second optical splitters are positioned at a preset distance between the first and second eyepieces and the first and second objective lenses, respectively.

4. (canceled)

5. The laser range-finding binocular of claim 1, further comprising a filter positioned between the first optical splitter and the laser transmitter.

6. The laser range-finding binocular of claim 1, further comprising a lens positioned between the display device and the first optical splitter such that the calculated distance displayed on the display device is propagated to the first eyepiece.

7. The laser range-finding binocular of claim 1, wherein the first eyepiece is movable with respect to the first objective lens and the second eyepiece is movable with respect to the second objective lens.

8. The laser range-finding binocular of claim 1, wherein each of the first and second optical splitters comprise beam splitting prisms.

9. The laser range-finding binocular of claim 8, wherein at least one of the first and second optical splitters comprise two beam splitting prisms in close proximity.

10. The laser range-finding binocular of claim 8, wherein at least one of the first and second optical splitters comprise two optical splitters combined with flat glass.

11. The laser-range finding binocular of claim 1, wherein the first objective lens is larger than the first eyepiece.

12. The laser-range finding binocular of claim 1, wherein the second objective lens is larger than the second eyepiece.

13. The laser range-finding binocular of claim 4, wherein the display device is an LCD display.

14. A laser range-finding binocular for measuring distance to a target object, comprising:
a first lens barrel comprising a first eyepiece and a first objective lens positioned at opposite ends of the first lens barrel;
a second lens barrel comprising a second eyepiece and a second objective lens positioned at opposite ends of the second lens barrel;
a first optical splitter positioned in the first lens barrel and a second optical splitter positioned in the second lens barrel, wherein each respective optical splitter is positioned between the corresponding eyepiece and objective lens;
a laser light transmitter positioned in the first lens barrel, operable to emit and direct a laser beam into the first optical splitter;
a laser light detector positioned in the second lens barrel, operable to detect laser light reflected from a target object;
processing circuitry operable to measure an elapsed time between activation of the laser light transmitter and detection of light by the laser light detector and to calculate a distance to the target object based on the elapsed time; and
a display device in communication with the processing circuitry, the display device operable to display the calculated distance to the target object such that the calculated distance is viewable through the first eyepiece and the first optical splitter.

15. The laser range-finding binocular of claim 14, further comprising a filter positioned between the first optical splitter and the laser transmitter.

16. The laser range-finding binocular of claim 14, further comprising:
a rotation mechanism positioned between and attached to the first and second lens barrels such that the first and second lens barrels are rotatable with respect to each other about the rotation mechanism.

17. The laser range-finding binocular of claim 14, further comprising a lens positioned between the display device and the first optical splitter such that the calculated distance displayed on the display device is propagated to the first eyepiece.

18. The laser range-finding binocular of claim 14, wherein the first eyepiece is movable with respect to the first objective lens and the second eyepiece is movable with respect to the second objective lens.
